(19) United States
(12) Patent Application Publication
(10) Pub. No.: US 2021/0094000 A1
(43) Pub. Date: Apr. 1, 2021

(54) METHOD FOR TRAPPING AND DECONTAMINATING A GASEOUS MEDIUM IN THE PRESENCE OF A MONOLITH COMPRISING TiO2 AND SILICA

(71) Applicant: IFP Energies Nouvelles, Rueil-Malmaison Cedex (FR)

(72) Inventors: Sophie BERNADET, Rueil-Malmaison Cedex (FR); Antoine FECANT, Rueil-Malmaison Cedex (FR); Serge RAVAINE, Cestas (FR); Renal-Vasco BACKOV, Bordeaux (FR); Michael LE BECHEC, Aussevielle (FR); Sylvie LACOMBE, Pau (FR)

(73) Assignee: IFP Energies Nouvelles, Rueil-Malmaison Cedex (FR)

(21) Appl. No.: 17/050,162

(22) PCT Filed: Apr. 12, 2019
(86) PCT No.: PCT/EP2019/059501

§ 371 Date: Oct. 23, 2020

(30) Foreign Application Priority Data
Apr. 26, 2018 (FR) 1853644

(51) Int. Cl. B01D 53/86; B01J 21/08; B01J 21/06; B01J 35/00; B01J 35/04; B01J 35/10; B01J 37/06; B01J 37/03; B01J 37/02; B01J 37/08; B01D 53/00

(52) U.S. Cl. CPC B01D 53/8668; B01D 2255/9207; B01J 21/063; B01J 35/004; B01J 35/04; B01J 35/1014; B01J 35/1019; B01J 35/1023; B01J 35/1038; B01J 35/1061; B01J 35/1076; B01J 37/06; B01J 37/036; B01J 37/0236; B01J 37/08; B01J 37/0201; B01D 53/007; B01D 2255/20707; B01D 2255/30; B01D 2255/802; B01D 2257/708; B01D 2255/9155; B01D 2259/804; B01D 2255/9202; B01D 2255/9205; B01J 21/08

(57) ABSTRACT

Method for treating a gaseous feedstock containing molecular oxygen and one or more volatile compounds, which method comprises the following steps:
a) bringing said gaseous feedstock containing molecular oxygen and one or more volatile organic compounds into contact with a monolith comprising silica and titanium dioxide, said monolith comprising a type-I macropore volume, of which the diameter of the pores is greater than 50 nm and less than or equal to 1000 nm, of between from 0.1 to 3 ml/g, and a type-II macropore volume, of which the diameter of the pores is greater than 1 μm and less than or equal to 10 μm, of between from 1 to 8 ml/g;
b) irradiating said monolith with at least one irradiation source producing at least one wavelength lower than 400 nm in order to convert said volatile organic compounds into carbon dioxide, said step b) being carried out at a temperature between −30° C. and +200° C. and at a pressure between 0.01 MPa and 70 MPa.

### TECHNICAL FIELD OF THE INVENTION

The field of the invention is that of the decontamination of a gaseous medium comprising volatile organic compounds by means of a photocatalytic process.

### PRIOR ART

Currently, there are many methods for decontaminating a gaseous medium, in particular air, which may contain volatile organic compounds (VOCs).

A first approach consists in bringing the gaseous medium into contact with an adsorbent (also referred to here as trapping mass) mainly consisting of activated carbon. However, the drawback of this type of adsorbent is that it must be periodically replaced in order to ensure the effectiveness of the system.

Another approach proposed for eliminating volatile organic compounds in a gaseous medium, in particular air, consists of the photocatalytic degradation of these compounds. Today, the devices used, mainly comprising titanium dioxide (TiO₂) as active phase, have the drawback of not completely mineralizing these volatile organic compounds, which can lead to release of these potentially harmful compounds in the gaseous medium. Furthermore, the photocatalytic systems known from the prior art suffer from poor stability and thus result in the need to replace the modules periodically, thus not solving the problem raised by the use of trapping mass based on activated carbon.

Moreover, one of the difficulties of existing photocatalytic systems relates to the use of the photocatalytic material in the form of powder. Indeed, in order to avoid the propagation of nanoparticles in the effluent to be treated or to avoid a tedious nanofiltration step, many studies have been devoted to the deposition of nanomaterials on various supports, such as paper, glass, steel, textiles, polymers or else ceramic materials.

Document FR2975309 discloses TiO₂ ou TiO₂—SiO₂ self-supporting monoliths as photocatalysts for air decontamination. However, these two types of materials have low levels of adsorption of volatile organic compounds. Furthermore, TiO₂—SiO₂ materials, for which the preparation process provides for the simultaneous supply of the Si precursor and the Ti precursor, do not exhibit any photocatalytic activity.

### SUBJECTS OF THE INVENTION

Surprisingly, the applicant has discovered that the use of a monolith based on silica and titanium dioxide, comprising a specific macroporous structure, makes it possible to achieve much higher adsorption capacities compared to adsorbents based on activated carbons and to porous monoliths known from the prior art, while having improved properties in terms of photocatalytic activity, in terms of stability, and in terms of degree of mineralization, compared to the photocatalytic materials according to the prior art. In a non-obvious manner, the use of a monolithic material according to the invention thus makes it possible to combine the two functions of the materials commonly proposed for the application of decontamination of the effluents to be treated, that is to say the trapping of the impurities contained in the effluent to be treated and the degradation thereof, while preventing the propagation of nanoparticles in the effluent, inducing significant performance gains.

The present invention relates to a method for treating a gaseous feedstock containing molecular oxygen and one or more volatile compounds, which method comprises the following steps:

a) bringing said gaseous feedstock containing molecular oxygen and one or more volatile organic compounds into contact with a monolith comprising silica and titanium dioxide, said monolith comprising a type-I macropore volume, of which the pore diameter is greater than 50 nm and less than or equal to 1000 nm, of between from 0.1 to 3 ml/g, and a type-II macropore volume, of which the pore diameter is greater than 1 μm and less than or equal to 10 μm, of between from 1 to 8 ml/g;

b) irradiating said monolith with at least one irradiation source producing at least one wavelength lower than 400 nm in order to convert said volatile organic compounds into carbon dioxide, said step b) being carried out at a temperature between −30° C. and +200° C. and at a pressure between 0.01 MPa and 70 MPa.

Preferably, said gaseous feedstock containing molecular oxygen and one or more volatile organic compounds is diluted with a diluent fluid.

Preferably, the irradiation source is an artificial irradiation source.

Preferably, the irradiation source produces at least one wavelength between 300 and 400 nm.

Preferably, step a) is carried out in a flow-through fixed bed reactor or a swept fixed bed reactor.

Preferably, said monolith has a mesopore volume, of which the pore diameter is greater than 2 nm and less than or equal to 50 nm, of between 0.01 and 1 ml/g, preferably between 0.05 and 0.5 ml/g.

Preferably, said monolith also has a macropore volume, of which the pore diameter is greater than 10 μm, of less than 0.5 ml/g.

Preferably, said monolith has a bulk density of between 0.05 and 0.5 g/ml.

Preferably, said monolith has a specific surface area of between 10 and 1000 m²/g, preferably between 50 and 600 m²/g.

Preferably, said monolith comprises a titanium dioxide content of between 5 and 70% by weight relative to the total weight of the monolith.

Preferably, said monolith is prepared according to the following steps:

1) a solution containing a surfactant is mixed with an acid solution;

2) at least one soluble silica precursor is added to the solution obtained in step 1);

3) optionally, at least one liquid organic compound that is immiscible with the solution obtained in step 2) is added to the solution obtained in step 2) so as to form an emulsion;

4) the solution obtained in step 2) or the emulsion obtained in step 3) is left to mature in the wet state so as to obtain a gel;

5) the gel obtained in step 4) is washed with an organic solution;

6) the gel obtained in step 5) is dried and calcined so as to obtain a silica-based monolith;

7) a solution comprising at least one soluble precursor of titanium dioxide is impregnated in the porosity of the monolith obtained in step 6);

8) optionally, the product obtained in step 7) is dried and calcined so as to obtain a silica-based monolith containing titanium dioxide.

Preferably, in step 8), drying is carried out at a temperature of between 5 and 120° C.

Preferably, in step 8), calcining is carried out in air with a first temperature stationary phase between 80 and 150° C. for 1 to 10 hours, then a second temperature stationary phase between 150 and 250° C. for 1 to 10 hours, and finally a third temperature stationary phase between 300 and 950° C. for 0.5 to 24 hours.

### DETAILED DESCRIPTION OF THE INVENTION

Definitions

Hereinbelow, the groups of chemical elements are given according to the CAS classification (CRC Handbook of Chemistry and Physics, published by CRC Press, Editor in Chief D. R. Lide, 81st edition, 2000-2001). For example, group VIII according to the CAS classification corresponds to the metals of columns 8, 9 and 10 according to the new IUPAC classification.

In the present description, “micropores” is understood to mean, according to IUPAC convention, pores of which the diameter is less than 2 nm; “mesopores” is understood to mean pores of which the diameter is greater than 2 nm and less than or equal to 50 nm and “macropores” is understood to mean pores of which the diameter is greater than 50 nm, and more particularly “typed macropores” is understood to mean pores of which the diameter is greater than 50 nm and less than or equal to 1000 nm (1 μm), and “type-II macropores” is understood to mean pores of which the diameter is greater than 1 μm and less than or equal to 10 μm.

In the present invention, according to European Council Directive 1999/13/ EC, “volatile organic compounds (VOCs)” is understood to mean any compound containing at least the element carbon and one or more of the following elements: hydrogen, halogen, oxygen, sulfur, phosphorus, silicon or nitrogen, with the exception of carbon dioxide, and having a vapor pressure of 0.01 kPa or more at a temperature of 273.15 K.

The volumes of the macropores and of the mesopores are measured by mercury intrusion porosimetry according to standard ASTM D4284-83 at a maximum pressure of 4000 bar (400 MPa), using a surface tension of 484 dyne/cm and a contact angle of 140°.

“Total pore volume” is understood to mean the volume measured with a mercury intrusion porosimeter according to standard ASTM D4284-83 at a maximum pressure of 4000 bar (400 MPa), using a surface tension of 484 dyne/cm and a contact angle of 140°. The wetting angle was taken equal to 140° by following the recommendations of the work “Techniques de l'ingénieur, traité analyse et caractérisation” [Techniques of the Engineer, Analysis Treatise and Characterization], pages 1050-1055, written by Jean Charpin and Bernard Rasneur.

The specific surface area is measured by nitrogen adsorption according to standard ASTM D 3663-78 established on the basis of the Brunauer, Emmett, Teller method, i.e. BET method, as defined in S. Brunauer, P. H. Emmett, E. Teller, J. Am. Chem. Soc., 1938, 60 (2), pp 309-319.

Description

The present invention relates to a method for treating a gaseous feedstock comprising molecular oxygen, such as air, capable of containing one or more volatile organic compounds (VOCs), said method comprising the following steps:

a) bringing a gaseous feedstock containing one or more volatile organic compounds and molecular oxygen into contact with a monolith based on silica and titanium dioxide, said monolith comprising a type-I macropore volume, i.e. a macropore volume of which the pore diameter is greater than 50 nm and less than or equal to 1000 nm (1 μm), of between from 0.1 to 3 ml/g, preferably between 0.2 and 2.5 ml/g, and a type-II macropore volume, i.e. a macropore volume of which the pore diameter is greater than 1 μm and less than or equal to 10 μm, of between 1 and 8 ml/g, preferably between 2 and 8 ml/g, and even more preferentially between 3 and 8 ml/g;

b) irradiating said monolith with at least one irradiation source producing at least one wavelength lower than 400 nm so as to break the volatile organic compounds down into carbon dioxide.

Step A)

According to step a) of the method according to the invention, the monolith is brought into contact with a gaseous feedstock containing one or more volatile organic compounds and molecular oxygen.

The feedstock treated according to the method is in gaseous form, and contains volatile organic compounds and also molecular oxygen. Preferably, the feedstock treated according to the method is air containing up to 10,000 ppm of volatile organic compounds. Among the volatile organic compounds, mention may be made of the following families of molecules: halogenated hydrocarbons, aromatic hydrocarbons, alkanes, alkenes, alkynes, aldehydes, ketones.

Optionally, the feedstock is diluted with a gaseous diluent fluid. The presence of a diluent fluid is not required for carrying out the invention; however, it may be useful to add said diluent to the feedstock in order to ensure the dispersion of the feedstock in the medium, a control of the adsorption of the reagents/products in the porosity of the monolith, the dilution of the products to limit their recombination and other parasitic reactions of the same order. The presence of a diluent fluid also makes it possible to control the temperature of the reaction medium which can thus compensate for the possible exo/endothermicity of the photocatalyzed reaction. The nature of the diluent fluid is chosen such that its influence is neutral on the reaction medium or that its possible reaction does not harm the performing of the desired volatile organic compound degradation reaction. Preferably, the gaseous diluent fluid is chosen from N₂, O₂ or air.

The gaseous feedstock containing one or more volatile organic compounds and molecular oxygen can be brought into contact with said monolith by any means known to those skilled in the art. Preferably, the gaseous feedstock containing one or more volatile organic compounds and molecular oxygen is brought into contact with said monolith in a flow-through fixed bed reactor or a swept fixed bed reactor.

When the implementation is in a flow-through fixed bed, said monolith is preferentially fixed within the reactor, and the gaseous feedstock containing one or more volatile organic compounds and molecular oxygen is sent through the photocatalytic bed.

When the implementation is in a swept fixed bed, said monolith is preferentially fixed within the reactor, and the gaseous feedstock containing one or more volatile organic compounds and molecular oxygen is sent over the photocatalytic bed.

When the implementation is in a fixed bed or in a swept bed, it can be carried out continuously.

Step B) of the Method According to the Invention

According to step b) of the method according to the invention, said monolith is irradiated with at least one irradiation source producing at least one wavelength lower than 400 nm so as to break the volatile organic compounds down into carbon dioxide by photocatalysis.

Photocatalysis is based on the principle of activation of a semiconductor (such as TiO₂) or a set of semiconductors such as the photocatalyst used in the method according to the invention, using the energy provided by the irradiation. Photocatalysis can be defined as the absorption of a photon, the energy of which is greater than or equal to the bandgap between the valence band and the conduction band, which induces the formation of an electron-hole pair in the semiconductor. There is therefore excitation of an electron at the level of the conduction band and formation of a hole on the valence band. This electron-hole pair will allow the formation of free radicals which will either react with compounds present in the medium or recombine according to various mechanisms. Each semiconductor has an energy difference between its conduction band and its valence band, or “bandgap”, which is specific to it.

A photocatalyst composed of one or more semiconductors can be activated by the absorption of at least one photon. Absorbable photons are those of which the energy is greater than the bandgap of the semiconductors. In other words, the photocatalysts can be activated by at least one photon with a wavelength corresponding to the energy associated with the bandgaps of the semiconductors constituting the photocatalyst or with a lower wavelength. The maximum wavelength absorbable by a semiconductor is calculated using the following equation:

$${λ}_{m ax} = \frac{h \times c}{{E}_{g}}$$

With λₘₐₓ the maximum wavelength absorbable by a semiconductor (in m), h the Planck constant (4.13433559×10⁻¹⁵ -eV·s), c the speed of light in a vacuum (299 792 458 m·s⁻¹) and Eg the bandgap of the semiconductor (in eV).

Any irradiation source emitting at least one wavelength suitable for activating said photocatalyst, that is to say absorbable by TiO₂, therefore less than 400 nm, can be used according to the invention. It is for example possible to use natural solar irradiation or an artificial irradiation source of laser, mercury Hg arc, xenon Xe, mercury-xenon Hg(Xe), deuterium D₂ or quartz tungsten halogen QTH lamp, incandescent lamp, fluorescent tube, plasma or light-emitting diode (LED) type. Preferably, the irradiation source is an artificial irradiation.

The irradiation source produces radiation of which at least a portion of the wavelengths is less than the maximum wavelength (λₘₐₓ) absorbable by the TiO₂ contained in the monolith. When the irradiation source is solar irradiation, it generally emits in the ultraviolet, visible and infrared spectrum, i.e. it emits a wavelength range from 280 nm to 2500 nm approximately (according to standard ASTM G173-03).

Preferably, the source emits at least in a wavelength range greater than 280 nm, very preferably from 300 nm to 400 nm.

The irradiation source provides a stream of photons which irradiates the reaction medium containing the monolith. The interface between the reaction medium and the light source varies according to the applications and the nature of the light source.

In one preferred embodiment, when solar irradiation is involved, the irradiation source is located outside the reactor and the interface between the two can be an optical window made of pyrex, quartz, organic glass or any other interface allowing the photons absorbable by the monolith according to the invention to diffuse from the external medium into the reactor.

The performing of said method is conditioned by the adsorption capacity of said monolith and also by the supply of photons suitable for the photocatalytic system for the envisioned reaction and therefore is not limited to a specific pressure or temperature range outside those which make it possible to ensure the stability of the material(s). The temperature range used for the method is generally from −30° C. to +200° C., preferably from −10 to 150° C., and very preferably from −10 to 100° C. The pressure range used for the method is generally from 0.01 MPa to 70 MPa (0.1 to 700 bar), preferably from 0.5 MPa to 2 MPa (0.5 to 20 bar). The method according to the invention can be carried out with a dry or wet gas up to 100% relative humidity; preferably, the gas to be treated contains from 0 to 60% relative humidity.

Monolith

The monolith used in the context of the method for treating a gaseous feedstock according to the invention comprises silica and titanium dioxide. Said monolith has a type-I macropore volume, i.e. a macropore volume of which the pore diameter is greater than 50 nm and less than or equal to 1000 nm (1 μm), of between from 0.1 to 3 ml/g, preferably between 0.2 and 2.5 ml/g, and even more preferentially between 1 and 2 ml/g. Furthermore, said monolith has a type-II macropore volume, i.e. a macropore volume of which the pore diameter is greater than 1 μm and less than or equal to 10 μm, of between 1 and 8 ml/g, preferably between 2 and 8 ml/g, and even more preferentially between 3 and 8 ml/g.

Preferably, the monolith comprises a titanium dioxide content of between 5 and 70% by weight relative to the total weight of the monolith.

The monolith can optionally be doped with one or more elements chosen from metallic elements, such as for example elements V, Ni, Cr, Mo, Fe, Sn, Mn, Co, Re, Nb, Sb, La, Ce, Ta, non-metallic elements, such as for example C, N, S, F, P, or with a mixture of metallic and non-metallic elements.

Preferably, the titanium dioxide contained in the monolith can be surface-sensitized with any organic molecules capable of absorbing photons.

Preferably, said monolith may contain at least one element M chosen from an element from groups VIIIB, IB, IIB and IIIA of the periodic table of elements in the metallic and/or oxide state. Preferably, the content of element(s) M in the metallic and/or oxide state is between 0.001 and 20% by weight relative to the total weight of the monolith.

Preferably, said monolith has a mesopore volume, of which the pore diameter is greater than 2 nm and less than or equal to 50 nm, of between 0.01 and 1 ml/g, preferably between 0.05 and 0.5 ml/g.

Preferably, said monolith also has a macropore volume, of which the pore diameter is greater than 10 μm, of less than 0.5 ml/g.

Preferably, said monolith has a bulk density of between 0.05 and 0.5 g/ml. The bulk density is calculated by forming the ratio of the weight of catalyst to its geometric volume.

Preferably, said monolith has a BET surface area of between 10 and 1000 m²/g, preferably between 50 and 600 m²/g, and even more preferentially between 100 and 300 m²/g.

Method for Preparing the Monolith

The monolith used in the context of the method according to the invention can be prepared by means of a specific preparation method, wherein the synthesis of the silica and titanium dioxide phases takes place during two distinct steps. Carrying out two distinct steps makes it possible in particular to avoid the formation of mixed compounds of the SiO₂—TiO₂ type in the very structure of the monolith, which would cause a loss of available photocatalytic material.

According to one variant, the method for preparing said monolith comprises the following steps:

1) a solution containing a surfactant is mixed with an acid solution;

2) at least one soluble silica precursor is added to the solution obtained in step 1);

3) optionally, at least one liquid organic compound that is immiscible with the solution obtained in step 2) is added to the solution obtained in step 2) so as to form an emulsion;

4) the solution obtained in step 2) or the emulsion obtained in step 3) is left to mature in the wet state so as to obtain a gel;

5) the gel obtained in step 4) is washed with an organic solution;

6) the gel obtained in step 5) is dried and calcined so as to obtain a silica-based monolith;

7) a solution comprising at least one soluble precursor of titanium dioxide is impregnated in the porosity of the monolith obtained in step 6);

8) optionally, the product obtained in step 7) is dried and calcined so as to obtain a silica-based monolith containing titanium dioxide.

The steps are described in detail below.

Step 1)

During step 1) of the method for preparing the monolith, a solution containing one or more surfactants is mixed with an acidic aqueous solution so as to obtain an acidic aqueous solution comprising one or more surfactants.

The surfactants may be anionic, cationic, amphoteric or nonionic. Preferably, the surfactants are chosen from polyethylene glycol, cetyltrimethylammonium bromide and myristyltrimethylammonium bromide, alone or as a mixture. The acidic agent is preferably selected from inorganic acids, such as nitric acid, sulfuric acid, phosphoric acid, hydrochloric acid and hydrobromic acid, and organic acids, such as carboxylic or sulfonic acids, alone or as a mixture. The pH of the mixture is preferably less than 4.

Step 2)

During step 2) of the method for preparing the monolith, at least one soluble silica precursor, preferably chosen from tetraethyl orthosilicate and tetramethyl orthosilicate, alone or as a mixture, is added.

Optionally, it is possible to add, to said precursor, another inorganic silica precursor of the ionic or colloidal sol type.

Preferably, the precursors/surfactants weight ratio is between 0.1 and 10.

Step 3) [Optional]

During step 3), at least one liquid organic compound that is immiscible with the solution obtained in step 2) is added to the solution obtained in step 2) so as to form an emulsion.

Preferably, the liquid organic compound is a hydrocarbon, or a mixture of hydrocarbons, having 5 to 15 carbon atoms. Preferably, the weight ratio of liquid organic compound/solution obtained in step 2) is between 0.2 and 5.

Step 4)

During step 4), the solution obtained in step 2) or the emulsion obtained in step 3) is left to mature in the wet state so as to obtain a gel.

Preferably, the maturation is carried out at a temperature of between 5 and 80° C. Preferably, the maturation is carried out for 1 to 30 days. It is during this step 4) that the synthesis of the silica (SiO₂) takes place.

Step 5)

During step 5), the gel obtained in step 4) is washed with an organic solution.

Preferably, the organic solution is acetone, ethanol, methanol, isopropanol, tetrahydrofuran, ethyl acetate or methyl acetate, alone or as a mixture. Preferably, the washing step is repeated several times.

Step 6)

During step 6), the gel obtained in step 5) is dried and calcined so as to obtain a silica-based monolith.

Preferably, the drying is carried out at a temperature of between 5 and 80° C. Preferably, the drying is carried out for 1 to 30 days. Optionally, absorbent paper can be used to accelerate the drying of the materials.

Preferably, the calcining is carried out as follows: a first temperature stationary phase between 120 and 250° C. for 1 to 10 hours, then a second temperature stationary phase between 300 and 950° C. for 2 to 24 hours.

Step 7)

During step 7), a solution comprising at least one soluble precursor of titanium dioxide is impregnated in the porosity of the monolith obtained in step 6). Preferably, the titanium precursor is chosen from an alkoxide, very preferably the titanium precursor is chosen from titanium isopropoxide and tetraethyl orthotitanate, alone or as a mixture.

Preferably, a maturation step is carried out in a humid atmosphere after the impregnation.

It is during this step 7) that the synthesis of the titanium dioxide (TiO₂) takes place.

Step 8) [Optional Step]

During step 8), the product obtained in step 7) is dried and calcined so as to obtain a monolith.

Preferably, a drying step is carried out at a temperature of between 5 and 120° C. and for 0.5 to 20 days.

Preferably, a calcining step is then carried out in air with a first temperature stationary phase between 80 and 150° C. for 1 to 10 hours, then a second temperature stationary phase between 150 and 250° C. for 1 to 10 hours, and finally a third temperature stationary phase between 300 and 950° C. for 0.5 to 24 hours.

Any element, or element precursor, M chosen from an element from groups VIIIB, IB, IIB and IIIA of the periodic table of elements can be introduced in any step of the method.

The following examples illustrate the invention without limiting the scope thereof.

### EXAMPLES

### Example 1: Material A (Not in Accordance With the Invention) Material A is a commercial activated carbon in the form of pellets (WS490, MBRAUN®)

### Example 2: Material B (Not in Accordance With the Invention)

Material B is a commercial material consisting of TiO₂ nanoparticles supported by quartz fibers, sold under the name Quartzel™ by the company Saint Gobain®. Quartzel™ is known to those skilled in the art for its excellent photocatalytic properties in air purification.

### Example 3: Material C (Not in Accordance With the Invention)

Material C is a monolith containing silica and titanium dioxide, wherein the SiO₂and TiO₂ phases were synthesized during the same step, such as the solid known as TiO₂/SiO₂-Dodecane described in Example 1 of patent application FR2975309.

Material C has a total porosity of 2.44 cm³/g, including a mesopore volume of 0.47 ml/g, a type-I macropore volume of 0.79 ml/g and a type-II macropore volume of 1.18 ml/g, and a bulk density of 0.33 g/cm³. Material C has a specific surface area of 365 m²/g. The content of Ti element measured by ICP-AES is 47.72% by weight, which makes an equivalent of 79.55% by weight of TiO₂ in material C.

### Example 4: Material D (Not in Accordance With the Invention)

Material D is a TiO₂ monolith, such as the solid known as TiO₂-Heptane described in Example 1 of patent application FR2975309. Material D has a total porosity of 0.52 ml/g, including a mesopore volume of 0.29 ml/g, a type-I macropore volume of 0.07 ml/g and a type-II macropore volume of 0.16 ml/g, and a bulk density of 1.1 g/cm³. Material D has a specific surface area of 175 m²/g.

### Example 5: Material E (in Accordance With the Invention)

1.12 g of myristyltrimethylammonium bromide (Aldrich™, purity>99%) are added to 2 ml of distilled water and then mixed with 1 ml of a hydrochloric acid solution (37% by weight, Aldrich™, purity 97%). 1.02 g of tetraethyl orthosilicate (Aldrich™, purity>99%) are added to the mixture and the whole thing is stirred until a mixture with a single-phase appearance is obtained.

7 g of dodecane (Aldrich™, purity>99%) are slowly introduced into the mixture with stirring until an emulsion is formed.

The emulsion is then poured into a Petri dish with an internal diameter of 5.5 cm, which is placed in a saturator for 7 days for gelling.

The gel obtained is then washed a first time with anhydrous tetrahydrofuran (Aldrich™, purity>99%), then with an anhydrous tetrahydrofuran/acetone mixture (VWR™, ACS grade) at 70/30 by volume twice in succession.

The gel is then dried at ambient temperature for 7 days. The gel is finally calcined in air in a muffle furnace at 180° C. for 2 hours, then at 650° C. for 5 hours. An SiO₂-based monolith is then obtained.

A solution containing 34 ml of distilled water, 44.75 ml of isopropanol (Aldrich™, purity>99.5%), 10.74 ml of hydrochloric acid (37% by weight, Aldrich™, purity 97%) and 10.50 ml of titanium isopropoxide (Aldrich™, purity 97%) is prepared with stirring. A portion of this solution corresponding to the pore volume is impregnated in the porosity of the monolith, then left to mature for 12 hours. The monolith is then dried under ambient atmosphere for 24 hours. The step is repeated a second time. The monolith is finally calcined in air in a muffle furnace at 120° C. for 2 hours, then at 180° C. for 2 hours and finally at 400° C. for 1 hour. A monolith is then obtained comprising TiO₂ in an SiO₂ matrix, such that the syntheses of the silica and titanium dioxide phases were carried out in two separate steps.

Material E has a mesopore volume of 0.20 ml/g, a type-I macropore volume of 1.15 ml/g and a type-II macropore volume of 5.8 ml/g. Material E has a specific surface area of 212 m²/g. The content of Ti element measured by ICP-AES is 27.35% by weight, which makes an equivalent of 52.1% by weight of TiO₂ in material E. Material E has a bulk density of 0.14 g/ml.

### Example 6: Use of the Materials in Adsorption and Photooxidation of Acetone

Materials A, B, C, D and E are subjected to a gas-phase acetone adsorption and photooxidation test in a continuous steel flow-through bed reactor fitted with a quartz optical window and a grid facing the optical window on which the material is deposited. Before each test, the materials were conditioned by thermodesorption at 115° C. for 12 hours. The tests are carried out at ambient temperature under atmospheric pressure by passing dry air containing 480 ppmV of acetone at a flow rate of 60 ml/min. The residual acetone content and the production of carbon dioxide gas produced from the photooxidation of the acetone are monitored by analyzing the effluent every 7 minutes by gas chromatography (GC FID/methanizer FID). The UV irradiation source is provided by an LED type lamp (High Power single chip LED 1W 365 nm Roithner Lasertechnik GmbM™). The irradiation power is maintained at 30 W/m² for a wavelength range of between 315 and 380 nm. The overall duration of each test is approximately 200 hours. The tests are carried out in two steps: a first step of equilibration without irradiation which makes it possible to estimate the amount of acetone adsorbed, and a second step of photooxidation under irradiation which makes it possible to estimate the photocatalytic performance results.

Two performance indices are reported in table 1 below for all of the materials evaluated. These are the adsorption capacity, calculated as the percentage of acetone adsorbed by mass relative to the mass of material used; and the degree of mineralization calculated as the percentage of CO₂ measured compared to the theoretical amount of CO₂ resulting from the photooxidation of the acetone (a value of 100% will indicate that no carbon product other than CO₂ is formed during the reaction).

TABLE 1
Acetone adsorption capacity and degree of acetone mineralization
of the trapping masses A, B, C, D (not in accordance with
the invention) and E (according to the invention)

| | | | Degree of |
|---|---|---|---|
| | | Acetone | acetone |
| | | adsorption | mineralization |
| Material | | (% by weight) | (%) |
| A (not in accordance | Activated | 4.8 | No activity |
| with the invention) | carbon | | |
| B (not in accordance | Quartzel ® | 2.1 | 100% |
| with the invention) | | | |
| C (not in accordance | Monolith | 18.7 | No activity |
| with the invention) | TiO₂—SiO₂- | | |
| | Dodecane | | |
| D (not in accordance | Monolith | 3.7 | 100% |
| with the invention) | TiO₂- | | |
| | Heptane | | |
| E (in accordance | Monolith | 41.3 | 100% |
| with the invention) | TiO₂/SiO₂ | | |

The acetone adsorption values show that the implementation according to the invention makes it possible to reach significantly higher levels even compared to materials known to be of very high capacity such as activated carbons. Furthermore, the degrees of acetone mineralization are at least as good as those obtained by the known implementations of the prior art.

### Example 7: Use of the Materials in Adsorption and Photooxidation of Toluene

Materials B and E are subjected to a gas-phase toluene adsorption and photooxidation test in a continuous steel flow-through bed reactor fitted with a quartz optical window and a frit facing the optical window on which the material is deposited. Before each test, the materials were conditioned by thermodesorption at 115° C. for 12 hours. The tests are carried out at ambient temperature under atmospheric pressure by passing dry air containing 70 ppmV of toluene at a flow rate of 60 ml/min. The residual toluene content and the production of carbon dioxide gas produced from the photooxidation of the toluene are monitored by analyzing the effluent every 7 minutes by gas chromatography (GC FID/methanizer FID). The UV irradiation source is provided by an LED type lamp (High Power single chip LED 1 W 365 nm Roithner Lasertechnik GmbM™). The irradiation power is always maintained at 30 W/m² for a wavelength range of between 315 and 380 nm. The overall duration of each test is approximately 100 hours. The tests are carried out in two steps: a first step of equilibration without irradiation which makes it possible to estimate the amount of toluene adsorbed, and a second step of photooxidation under irradiation which makes it possible to estimate the photocatalytic performance results.

Two performance indices are reported in table 2 below for all of the materials evaluated. These are the adsorption capacity, calculated as the percentage of toluene adsorbed by mass relative to the mass of material used; and the degree of mineralization calculated as the percentage of CO₂ measured compared to the theoretical amount of CO₂ resulting from the photooxidation of the toluene (a value of 100% will indicate that no carbon product other than CO₂ is formed during the reaction).

TABLE 2
Toluene adsorption capacity and degree of toluene mineralization
of the trapping masses B (not in accordance with the
invention) and E (according to the invention)

| | | | Degree of |
|---|---|---|---|
| | | Toluene | toluene |
| | | adsorption | mineralization |
| Material | | (% by weight) | (%) |
| B (not in accordance | Quartzel ® | 0.72 | 23% |
| with the invention) | | | |
| E (in accordance | Monolith | 1.60 | 55% |
| with the invention) | TiO₂/SiO₂ | | |

The toluene adsorption values show that the implementation according to the invention makes it possible to reach significantly higher levels than implementations known from the prior art. Furthermore, the degree of toluene mineralization is significantly higher for an implementation according to the invention. Finally, the use of material E according to the invention makes it possible to obtain photocatalytic activities that are very stable, contrary to the use of Quartzel® (material B). With the Quartzel® material, a rapid deactivation of the material is observed, which is characterized by a reduction in the production of carbon dioxide and a significant yellowing of the material during the test phase under irradiation.

1. A method for treating a gaseous feedstock containing molecular oxygen and one or more volatile compounds, which method comprises the following steps:
a) bringing said gaseous feedstock containing molecular oxygen and one or more volatile organic compounds into contact with a monolith comprising silica and titanium dioxide, said monolith comprising a type-I macropore volume, of which the pore diameter is greater than 50 nm and less than or equal to 1000 nm, of between from 0.1 to 3 ml/g, and a type-II macropore volume, of which the pore diameter is greater than 1 μm and less than or equal to 10 μm, of between from 1 to 8 ml/g;
b) irradiating said monolith with at least one irradiation source producing at least one wavelength lower than 400 nm in order to convert said volatile organic compounds into carbon dioxide, said step b) being carried out at a temperature between −30° C. and +200° C. and at a pressure between 0.01 MPa and 70 MPa.

2. The method as claimed in claim 1, wherein said gaseous feedstock containing molecular oxygen and one or more volatile organic compounds is diluted with a diluent fluid.

3. The method as claimed in claim 1, wherein the irradiation source is an artificial irradiation source.

4. The method as claimed in claim 1, wherein the irradiation source produces at least one wavelength between 300 and 400 nm.

5. The method as claimed in claim 1, wherein step a) is carried out in a flow-through fixed bed reactor or a swept fixed bed reactor.

6. The method as claimed in claim 1, wherein said monolith has a mesopore volume, of which the pore diameter is greater than 2 nm and less than or equal to 50 nm, of between 0.01 and 1 ml/g, preferably between 0.05 and 0.5 ml/g.

7. The method as claimed in claim 1, wherein said monolith also has a macropore volume, of which the pore diameter is greater than 10 μm, of less than 0.5 ml/g.

8. The method as claimed in claim 1, wherein said monolith has a bulk density of between 0.05 and 0.5 g/ml.

9. The method as claimed in claim 1, wherein said monolith has a specific surface area of between 10 and 1000 m²/g, preferably between 50 and 600 m²/g.

10. The method as claimed in claim 1, wherein said monolith comprises a titanium dioxide content of between 5 and 70% by weight relative to the total weight of the monolith.

11. The method as claimed in claim 1, wherein said monolith is prepared according to the following steps:
1) a solution containing a surfactant is mixed with an acid solution;
2) at least one soluble silica precursor is added to the solution obtained in step 1);
3) optionally, at least one liquid organic compound that is immiscible with the solution obtained in step 2) is added to the solution obtained in step 2) so as to form an emulsion;
4) the solution obtained in step 2) or the emulsion obtained in step 3) is left to mature in the wet state so as to obtain a gel;
5) the gel obtained in step 4) is washed with an organic solution;
6) the gel obtained in step 5) is dried and calcined so as to obtain a silica-based monolith;
7) a solution comprising at least one soluble precursor of titanium dioxide is impregnated in the porosity of the monolith obtained in step 6);
8) optionally, the product obtained in step 7) is dried and calcined so as to obtain a silica-based monolith containing titanium dioxide.

12. The method as claimed in claim 11, wherein, in step 8), drying is carried out at a temperature between 5 and 120° C.

13. The method as claimed in claim 11, wherein, in step 8), calcining is carried out in air with a first temperature stationary phase between 80 and 150° C. for 1 to 10 hours, then a second temperature stationary phase between 150 and 250° C. for 1 to 10 hours, and finally a third temperature stationary phase between 300 and 950° C. for 0.5 to 24 hours.
